(19) United States
(12) Patent Application Publication
(10) Pub. No.: US 2006/0218495 A1
(43) Pub. Date: Sep. 28, 2006

(54) Document processing device

(75) Inventors: Masanori Onda, Ashigarakami-gun (JP); Katsuhiko Itonori, Ashigarakami-gun (JP); Hideaki Ashikaga, Ashigarakami-gun (JP); Shunichi Kimura, Ashigarakami-gun (JP); Masanori Satake, Ebina-shi (JP); Masahiro Kato, Ashigarakami-gun (JP); Hiroki Yoshimura, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/203,249

(22) Filed: Aug. 15, 2005

(30) Foreign Application Priority Data
Mar. 25, 2005 (JP) 2005-090174

(51) Int. Cl. G06F 17/00; G06F 17/24

(52) U.S. Cl. 715/540

(57) ABSTRACT

The invention provides a document processing device that has a translation section that translates character data included in a designated area of a manuscript, and a replacing section that when the translated character data contains a reference term that refers to a target term that is not specified in the translated character data, replaces the reference term in the translated character data with a translation of the target term existing in an area of the manuscript other than the designated area.

### BACKGROUND OF THE INVENTION

1. Field of the Invention

The present invention relates to a document processing device that reads, translates, and outputs a document.

2. Description of the Related Art

In order to achieve the efficient usage of foreign language documents, devices have been developed that machine translate and output documents.

In the devices, the translation of only a portion of the document can be used as an abstract of the document, or as an index. However, because the information included before or after the extracted portion is omitted, when translated as-is, the results of the translation may be lack a comprehensible meaning.

The present invention was made in view of the above circumstances and provides a document processing device that, even when a portion of a document is translated, can provide a translation having a comprehensible meaning.

### SUMMARY OF THE INVENTION

In order to address the issues described above, the present invention provides, in one aspect, a document processing device that has a translation section that translates character data included in a designated area of a manuscript; and a replacing section that when the translated character data contains a reference term that refers to a target term that is not specified in the translated character data, replaces the reference term in the translated character data with a translation of the target term existing in an area of the manuscript other than the designated area.

With the document processing device according to the present invention, even when designating a portion of a document and performing translation work, it is possible to automatically search for required information and output a translated document with a high degree of completeness.

### BRIEF DESCRIPTION OF THE DRAWINGS

Embodiments of the present invention will be described in detail based on the following figures, wherein:

FIG. 1 is a block diagram that shows a configuration of a document processing device according to an embodiment of this invention;

FIG. 2 is a table that explains the content of a reference term database;

FIG. 3 is a view showing a specific example of a document processing operation; and

FIG. 4 is a flowchart that shows an operation of a document processing device according to an embodiment of this invention.

### DETAILED DESCRIPTION OF THE INVENTION

Below follows a description of an embodiment of the present invention, with reference to the drawings. FIG. 1 is a block diagram that shows a configuration of a document processing device according to this embodiment. This document processing device is provided with a reading section 10 that reads a document to be sent and outputs image data, an area extraction section 12 that extracts an area in which document processing should be performed for this image data, a character recognition section 14 that performs character recognition and extracts character data for the image data of the extracted area, a translation section 16 that translates the character data output by the character recognition section 14 from a translation source language to a translation target language that are each designated in advance, a content checking section 18 that checks the content of the translation results and judges whether or not there are any reference terms with an unspecified meaning, and an output section 20 that outputs the translated document to an appropriate device after the translation has been checked. Here, “reference term” means a word that refers to another word, and can take the place of the word to which it refers, in the same manner as a pronoun.

The reading section 10, for example, is publicly known technology that, while moving the document along the reading face of the reading device, converts the brightness of each part of the document to binary image data, and ordinarily includes a hardware portion called a scanner that has an automatic paper feed mechanism. The area extraction section 12 extracts a portion of the image data, reflecting in some form the intent of a user. In this embodiment, a user interface 22 is provided in order for a person to give an instruction for the area extraction section 12. This is performed, for example, by the area extraction section 12 displaying the image data obtained by the reading section 10 on a display, and the user designating an area on the display using a mouse or the like. A suitable configuration can be adopted for the user interface 22, such as a keyboard, touch panel, or the like, and if there is an existing configuration in the document processing device, that may also be used.

And, for example, it is also possible to indicate an extraction area by the user directly writing a border into the document. In this case, by having a function that directly judges that border in the area extraction section 12, the user interface 22 is unnecessary. This method conveniently saves the time needed to process a large amount of documents, because when a user takes a copy of an original document and writes a border into that copy, afterwards the device will process the document automatically.

The character recognition section 14 performs character recognition of the image data in the language of the source document designated in advance, and generates character data of the document. The translation section 16 is a conventional translation section that refers to a dictionary database, which is a corresponding table of the translation source language and the translation target language, and performs translation. The output section 20 may appropriately select a printer, display, or memory section. When the source document includes graphic information other than text, such as graphics, photographs, and the like, the output section 20 may recombine the translation results with the graphic information and output the recombined data.

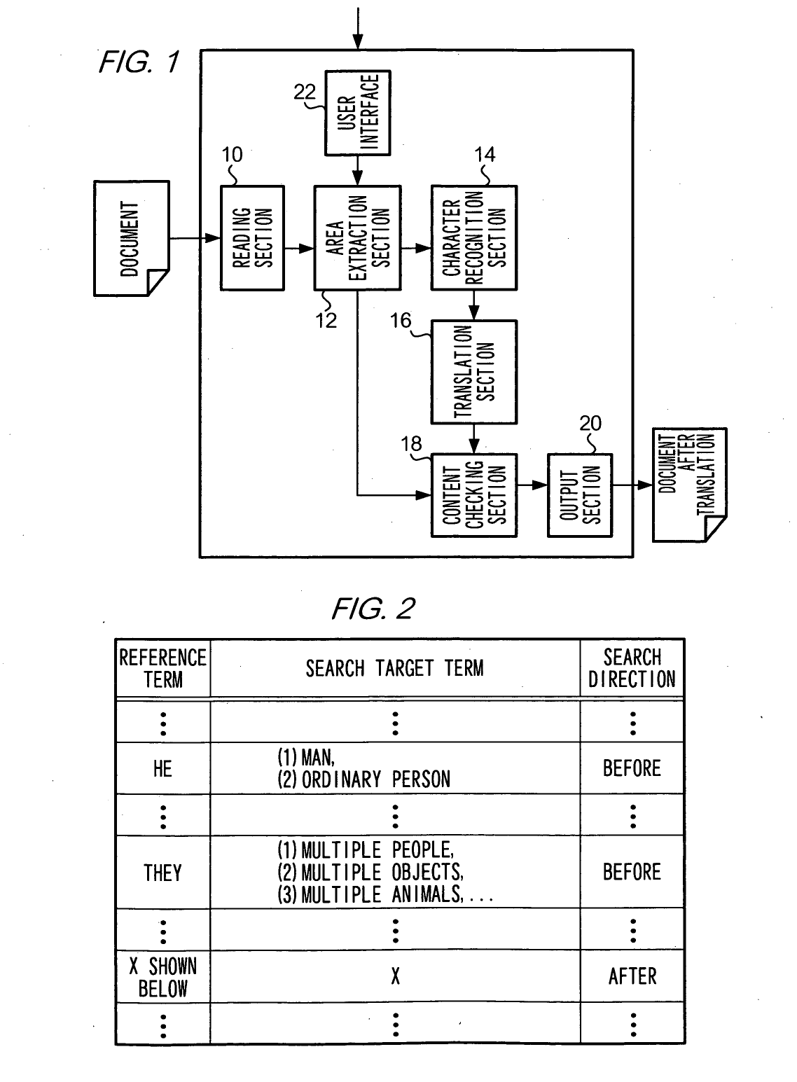

The content checking section 18 retrieves reference terms from the content of the translation results. The content checking section 18 has a reference term database wherein these sorts of reference terms are stored beforehand, in a table format as shown in FIG. 2. In this table TBL, the reference terms are set in the left column, candidates for the target terms that correspond to those reference terms are set in the center column, and the search direction is set in the right column. Because there is not ordinarily a single target term corresponding to a single reference term, multiple corresponding candidate terms are set.

The candidate terms in the column of the search target term of the table TBL shown in FIG. 2 are not words to be directly searched, but are set as terms of groups of subjects having such characteristics. For example, the concepts “man” and “ordinary person” are set as the target terms of the reference term “he”. Also, as terms consolidated in the term “man”, words that are applicable to “man's name”, “noun indicating a man”, “person engaged in an occupation normally performed by a man”, and the like are all included. These conceptual terms subordinate to “man” are also stored in the table TBL. Subordinate conceptual terms may also be stored in a dictionary of the translation section 16, without being stored in the table TBL. For example, if a hierarchical structure is adopted such that a subordinate conceptual term corresponds to the keyword “man” as an explanation of the target term, it is possible to retrieve target terms using a dictionary database.

Also, if multiple candidates appear when a search is performed, one of the candidates is selected by a rule determined in advance. This rule is determined such that the term at the position closest to the reference term (position in the text passage) is retrieved, or the like. And, this rule may be used in combination with a rule that confers a frequency of occurrence to each term and establishes a priority, or the like.

Conceptual terms such as “multiple people”, “multiple objects”, and “multiple animals” are set as target terms for “they” shown in FIG. 2. In this case as well, for example, the definition “person's name and person's name (portion in which the names of people are expressed in succession)” is set as a subordinate conceptual term of “multiple people”.

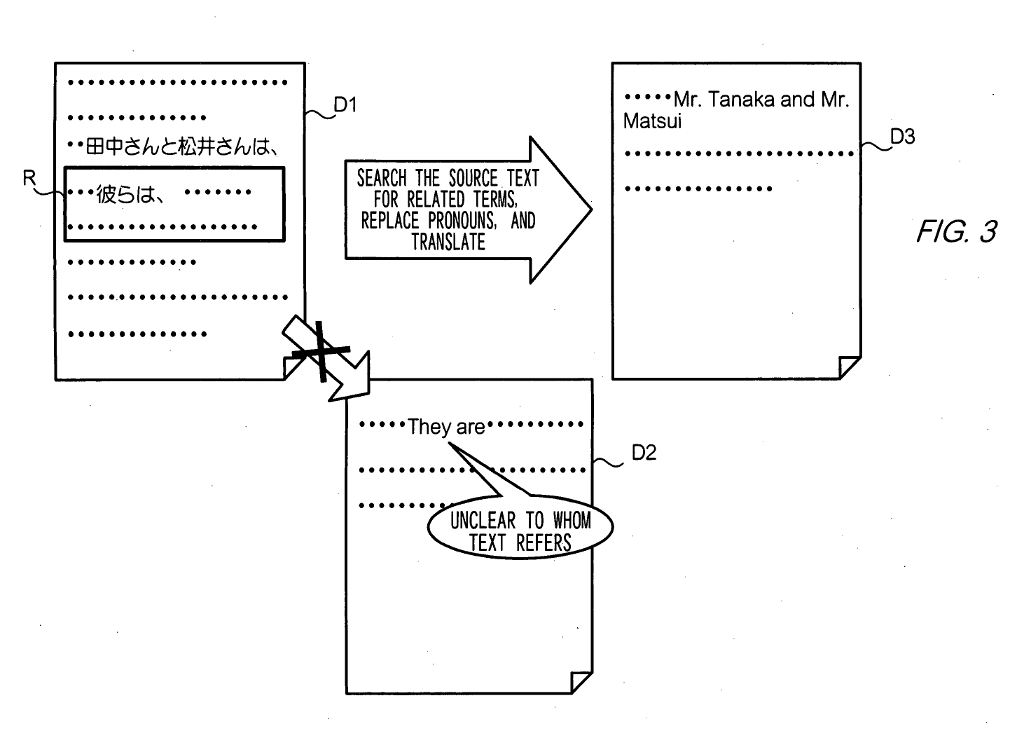

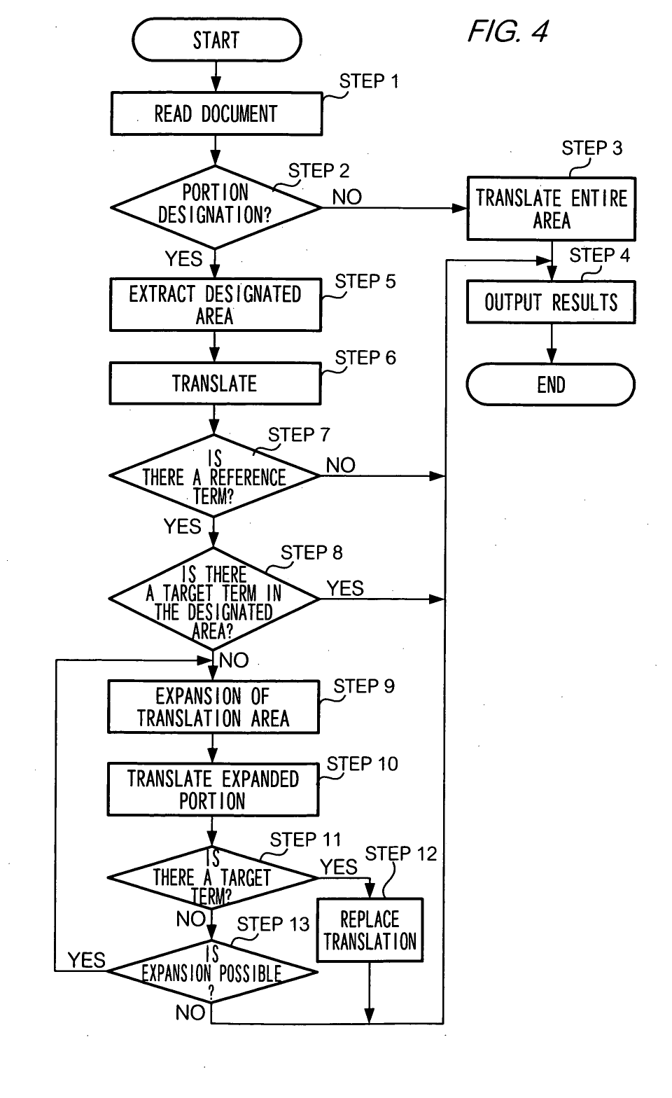

The operation of this embodiment will be explained below. FIG. 3 is a drawing that shows the flow of document processing using an example sentence. D1 indicates an original sentence written in Japanese, D2 indicates a translation of that sentence into English as-is, and D3 indicates a translation of that sentence according to an embodiment of this invention. Below, the operation of the document processing device in the process shown in FIG. 3 will be explained with reference to the flowchart shown in FIG. 4.

A manuscript is read by the reading section 10 (Step 1), and the area extraction section 12 checks whether or not there is a portion designation (Step 2). When a portion is designated by marking the manuscript, the presence or absence of a portion designation is judged on the image data. In a system wherein a user individually makes a designation for the image data, document image data is opened on a display or the like, the user is prompted to designate an area, and the designation is judged according to the response of the user. When there is no portion designation, the character recognition section 14 and the translation section 16 operate as usual, the entire area is translated (Step 3) and the output section 20 outputs the results (Step 4).

When it is judged in Step 2 that there is a portion designation, the area extraction section 12 extracts that designated area (Step 5), and performs character recognition and translation (Step 6). Next, the content checking section 18 checks whether or not there are reference terms in the results of the translation (Step 7). This is performed with reference to the left column of the table shown in FIG. 2. If these words are not present in the designated area, the results are output as-is. (Step 4). In Step 7, when reference terms are found, it is judged whether or not there are target terms corresponding to those reference terms in the designated area (Step 8).

In the embodiment shown in FIG. 3, because the reference term is “they” as shown in D2, the target terms are searched in the order (1) multiple people, (2) multiple objects, (3) multiple animals, and so on. This search direction is designated as being the direction of “before”, namely prior to the reference term, in the table TBL. And, when there is a target term in the designated area, the reference term is output as-is (Step 4). The reason for this is that if it is a target term in the text passage of the designated area that corresponds to the reference term, the meaning is understood without replacing the target term with the reference term, due to the fact that in that area the word that the reference term indicates clearly corresponds to the target term. On the other hand, if a word corresponding to the reference term is not found, the translation area expands ahead in the same direction as the search (Step 9). The expansion is performed with in units of an appropriate quantity of text, and here it is being performed in units of paragraphs. The expanded portion is translated (Step 10), and in this area a target term search is performed again (Step 11).

In Step 11, if there is a target term in the expanded area, that portion is translated, the translation of the target term is replaced with the corresponding reference term translation (Step 12), and the result is output (Step 4). In the example shown in FIG. 3, there is the definition “person's name and person's name (portion in which the names of people are successively expressed)” as words included in the concept “multiple people”, and so applicable words are found in the initial expanded portion. Thus, in Step 12, as shown in D3 of FIG. 3, “they” is replaced by “Mr. Tanaka and Mr. Matsui”. Ordinarily, the target term for the reference term is closest, and so the word initially found in the search direction can be selected as the target term, but as a standard for selection when there are multiple candidates, other than proximity in terms of distance, it is possible to consider proximity in terms of content, priority based on frequency of occurrence prescribed in advance, and the like.

In Step 11, when there is no target term in the expanded area, the possibility of further expansion is judged (Step 13), and when expansion is possible, the procedure returns to Step 9 and the steps through Step 11 are repeated. When there is no space to expand in the manuscript, the results are output with the reference term remaining as-is (Step 4). In this case, it is possible to output the results with a comment attached stating that the reference term content is unclear, and provide a warning to this effect by a separate method (such as a display by a display section or audio guidance using a speech synthesis device). A user can adopt a policy of supplying the previous page to the reading section or the like in response to such a warning. And, when designating a portion and translating in this way, because it is possible that there is necessary information on the pages before and after the designated portion, it is also possible to initially include the pages before and after the designated portion when reading the document.

In the above embodiment, the reference term is a pronoun, and words mentioned earlier in the text are searched, but among the reference terms there are also cases when the target term is explained after the reference term, as in “X as described below”. In such a case, the searched target term is “X” itself, and when replacing the search results, the replacement also includes that explanation.

In this embodiment, the presence or absence of a reference term is checked after translation is performed, but this may also be checked in the original text. In that case, all of the work of the content checking section 18 is performed in the language of the translation source, including the replacement in Step 12 of FIG. 4, and the translation work of Step 3 is performed afterwards.

As described above, the present invention provides, in one aspect, a document processing device that has a translation section that translates character data included in a designated area of a manuscript; and a replacing section that when the translated character data contains a reference term that refers to a target term that is not specified in the translated character data, replaces the reference term in the translated character data with a translation of the target term existing in an area of the manuscript other than the designated area.

As described above, the present invention also provides, in one aspect, a document processing device that has a replacing section that when character data included in a designated area of a manuscript contains a reference term that refers to a target term that is not specified in the character data, replaces the reference term in the character data with the target term existing in an area of the manuscript other than the designated area; and a translation section that translates the character data included in the designated area.

According to one of foregoing embodiments of the invention, the designated area may be designated by markings on the manuscript. According to one of foregoing embodiments of the invention, the document processing device may further comprise an input section for a user to designate the designated area.

According to one of foregoing embodiments of the invention, when the target term is not specified, the translated character data containing a message that the target term is not specified may be outputted. According to one of foregoing embodiments of the invention, the document processing device may further comprise a warning section that provides a warning to a user when the target term is not specified. Further, according to one of foregoing embodiments of the invention, the target term may be specified using a table defining a correspondence between the target term and the reference term.

The present invention also provides, in one aspect, a method of processing character data that has translating character data included in a designated area of a manuscript; and replacing, when the translated character data contains a reference term that refers to a target term that is not specified in the translated character data, the reference term in the translated character data with a translation of the target term existing in an area of the manuscript other than the designated area.

The present invention also provides, in one aspect, a method of processing character data that has replacing, when character data included in a designated area of a manuscript contains a reference term that refers to a target term that is not specified in the character data, the reference term in the character data with the target term existing in an area of the manuscript other than the designated area; and translating the character data included in the designated area.

The present invention also provides, in one aspect, a computer readable recording medium recording a program that causes a computer to execute one of the foregoing methods.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-090174 filed on Mar. 25, 2005 including specification, claims, drawings and abstract is incorporated herein by reference in its entirety.

1. A document processing device comprising:
a translation section that translates character data included in a designated area of a manuscript; and
a replacing section that when the translated character data contains a reference term that refers to a target term that is not specified in the translated character data, replaces the reference term in the translated character data with a translation of the target term existing in an area of the manuscript other than the designated area.

2. A document processing device comprising:
a replacing section that when character data included in a designated area of a manuscript contains a reference term that refers to a target term that is not specified in the character data, replaces the reference term in the character data with the target term existing in another portion of the designated area; and
a translation section that translates the character data included in the designated area.

3. The document processing device according to claim 1, wherein the designated area is designated by markings on the manuscript.

4. The document processing device according to claim 2, wherein the designated area is designated by markings on the manuscript.

5. The document processing device according to claim 1, further comprising an input section for a user to designate the designated area.

6. The document processing device according to claim 2, further comprising an input section for a user to designate the designated area.

7. The document processing device according to claim 1, wherein when the target term is not specified, the translated character data containing a message that the target term is not specified is outputted.

8. The document processing device according to claim 2, wherein when the target term is not specified, the translated character data containing a message that the target term is not specified is outputted.

9. The document processing device according to claim 1, further comprising a warning section that provides a warning to a user when the target term is not specified.

10. The document processing device according to claim 2, further comprising a warning section that provides a warning to a user when the target term is not specified.

11. The document processing device according to claim 1, wherein the target term is specified using a table defining a correspondence between the target term and the reference term.

12. The document processing device according to claim 2, wherein the target term is specified using a table defining a correspondence between the target term and the reference term.

13. A method of processing character data comprising:
translating character data included in a designated area of a manuscript; and
replacing, when the translated character data contains a reference term that refers to a target term that is not specified in the translated character data, the reference term in the translated character data with a translation of the target term existing in an area of the manuscript other than the designated area.

14. A method of processing character data comprising:
replacing, when character data included in a designated area of a manuscript contains a reference term that refers to a target term that is not specified in the character data, the reference term in the character data with the target term existing in an area of the manuscript other than the designated area; and
translating the character data included in the designated area.

15. A computer readable recording medium recording a program for causing a computer to execute:
translating character data included in a designated area of a manuscript; and
replacing, when the translated character data contains a reference term that refers to a target term that is not specified in the translated character data, the reference term in the translated character data with a translation of the target term existing in an area of the manuscript other than the designated area.

16. A computer readable recording medium recording a program for causing a computer to execute:
replacing, when character data included in a designated area of a manuscript contains a reference term that refers to a target term that is not specified in the character data, the reference term in the character data with the target term existing in an area of the manuscript other than the designated area; and
translating the character data included in the designated area.
